(19) United States
(12) Patent Application Publication
(10) Pub. No.: US 2025/0111479 A1
(43) Pub. Date: Apr. 3, 2025

(54) SIGNAL PROCESSING APPARATUS, METHOD FOR CONTROLLING SIGNAL PROCESSING APPARATUS, AND STORAGE MEDIUM

(71) Applicant: CANON KABUSHIKI KAISHA, Tokyo (JP)

(72) Inventor: TAKUYA KOSUGE, Kanagawa (JP)

(21) Appl. No.: 18/904,588

(22) Filed: Oct. 2, 2024

(30) Foreign Application Priority Data
Oct. 3, 2023 (JP) 2023-171951

(51) Int. Cl. G06T 5/50; G06T 7/90; G06V 10/25; G06V 10/60

(52) U.S. Cl. CPC G06T 5/50; G06T 7/90; G06V 10/25; G06V 10/60; G06T 2207/20221

(57) ABSTRACT

A signal processing apparatus comprising one or more processors that function as a first acquisition unit configured to acquire image data obtained by an imaging apparatus capturing an image of an object and a background video image displayed on a background display, an extraction unit configured to extract information about a background video image area and an object area in the image data, a first generation unit configured to generate a first indicator indicating at least one of characteristics, a second generation unit configured to generate a second indicator indicating a same type of characteristic as a type of the first indicator and a combination unit configured to output combined image data by combining the first indicator, the second indicator, and the image data.

### BACKGROUND

### Field of the Disclosure

The present disclosure relates to a signal processing apparatus, a method for controlling the signal processing apparatus, and a storage medium.

### Description of the Related Art

In-camera visual effects (VFX) virtual production using light-emitting diode (LED) walls has been expanding. An LED wall refers to a display apparatus including LEDs arranged in a grid pattern. In in-camera VFX, previously captured images are displayed on the LED wall. Actors and a studio set are positioned between the LED wall and a camera, and an image of the LED wall, actors, and studio set is captured. In the image captured using in-camera VFX, a partial area that includes the actors and the studio set will be referred to as a real area (object area). A partial area that includes the LED wall will be referred to as a virtual area (background video area).

In virtual production, there is a demand to separately analyze the virtual area and the real area using devices such as waveform monitors and vectorscopes. The virtual area is an image that is captured by a first camera, displayed on the LED wall, and captured again by a second camera. In contrast, the real area is an image directly captured by the second camera. Due to the difference in the imaging techniques, there can be a difference in image quality between the virtual and real areas, which is desirably checked. As employed herein, images include both moving images and still images.

For example, Japanese Patent Application Laid-Open No. 2017-16260 discusses a technique for displaying a vectorscope for a partial area of an image. As a method for specifying the partial area, a method where the user specifies the spatial area using a touchscreen is discussed.

According to the method discussed in Japanese Patent Application Laid-Open No. 2017-16260, a vectorscope can be displayed for a partial area. However, to analyze a virtual area and a real area separately involves the user specifying the areas. The method also involves specifying an area in a moving image each time the area moves.

### SUMMARY

The present disclosure has been made in consideration of the above situation, and is directed to providing a signal processing apparatus and a method of controlling the signal processing apparatus that can conveniently analyze a virtual area and a real area separately and are suitable for virtual production.

According to an aspect of the present disclosure, a signal processing apparatus comprising one or more processors that execute a program stored in a memory and thereby function as a first acquisition unit configured to acquire image data obtained by an imaging apparatus capturing an image of an object and a background video image displayed on a background display, an extraction unit configured to extract information about a background video image area and an object area in the image data, a first generation unit configured to generate a first indicator indicating at least one of characteristics including luminance, color, and a spatial frequency of the background video image area, a second generation unit configured to generate a second indicator indicating a same type of characteristic as a type of the first indicator generated by the first generation unit among characteristics including luminance, color, and a spatial frequency of the object area, and a combination unit configured to output combined image data by combining the first indicator, the second indicator, and the image data.

Further features of the present disclosure will become apparent from the following description of exemplary embodiments with reference to the attached drawings.

### BRIEF DESCRIPTION OF THE DRAWINGS

FIG. 1 is a block diagram illustrating a configuration example of a signal processing apparatus according to one or more aspects of the present disclosure.

FIG. 2 is a block diagram illustrating a configuration example of an imaging apparatus according to one or more aspects of the present disclosure.

FIG. 3 is a block diagram illustrating a connection example of apparatuses according to one or more aspects of the present disclosure.

FIG. 4 is a diagram illustrating an outline of in-camera virtual effects (VFX) imaging according to one or more aspects of the present disclosure from a bird's eye point of view.

FIG. 5 is a diagram illustrating an example of captured moving image data according to one or more aspects of the present disclosure.

FIG. 6 is a diagram illustrating a display example of combined moving image data according to one or more aspects of the present disclosure.

FIG. 7 is a block diagram illustrating a configuration example of a signal processing apparatus according to one or more aspects of the present disclosure.

FIG. 8 is a block diagram illustrating a configuration example of a display apparatus according to one or more aspects of the present disclosure.

FIG. 9 is a block diagram illustrating a connection example of apparatuses according to one or more aspects of the present disclosure.

FIG. 10 is a diagram illustrating an example of captured moving image data according to one or more aspects of the present disclosure.

FIG. 11 is a diagram illustrating a display example of combined moving image data according to one or more aspects of the present disclosure.

FIG. 12 is a diagram illustrating a drawing example of a first waveform monitor according to one or more aspects of the present disclosure.

FIG. 13 is a diagram illustrating a drawing example of a first chromaticity diagram according to one or more aspects of the present disclosure.

FIG. 14 is a block diagram illustrating a configuration example of a signal processing apparatus according to one or more aspects of the present disclosure.

FIG. 15 is a block diagram illustrating a connection example of apparatuses according to one or more aspects of the present disclosure.

FIG. 16 is a diagram illustrating a display example of combined moving image data according to one or more aspects of the present disclosure.

FIG. 17 is a block diagram illustrating a configuration example of a signal processing apparatus according to one or more aspects of the present disclosure.

FIG. 18 is a block diagram illustrating a connection example of apparatuses according to one or more aspects of the present disclosure.

FIG. 19 is a diagram illustrating a display example of combined moving image data according to one or more aspects of the present disclosure.

FIG. 20 is a diagram illustrating a drawing example of a first waveform monitor according to one or more aspects of the present disclosure.

FIG. 21 is a flowchart illustrating a control procedure according to one or more aspects of the present disclosure.

FIG. 22 is a diagram illustrating a display example of combined moving image data according to one or more aspects of the present disclosure.

FIG. 23 is a block diagram illustrating a configuration example of a signal processing apparatus according to one or more aspects of the present disclosure.

FIGS. 24A and 24B are diagrams illustrating an example of first input moving image data and second input moving image data according to one or more aspects of the present disclosure.

FIG. 25 is a diagram illustrating an example of moving image data according to one or more aspects of the present disclosure.

FIG. 26 is a diagram illustrating a display example of combined moving image data according to one or more aspects of the present disclosure.

FIG. 27 is a diagram illustrating a display example of combined moving image data according to one or more aspects of the present disclosure.

FIG. 28 is a diagram illustrating a display example of the combined moving image data according to one or more aspects of the present disclosure.

FIG. 29 is a diagram illustrating a display example of combined moving image data according to one or more aspects of the present disclosure.

FIG. 30 is a diagram illustrating an example of a distance graph according to one or more aspects of the present disclosure.

FIG. 31 is a diagram illustrating an example of the distance graph according to one or more aspects of the present disclosure.

### DESCRIPTION OF THE EMBODIMENTS

Hereinafter, desired exemplary embodiments of the present disclosure will be described in detail with reference to the accompanying drawings.

### Configuration of Signal Processing Apparatus

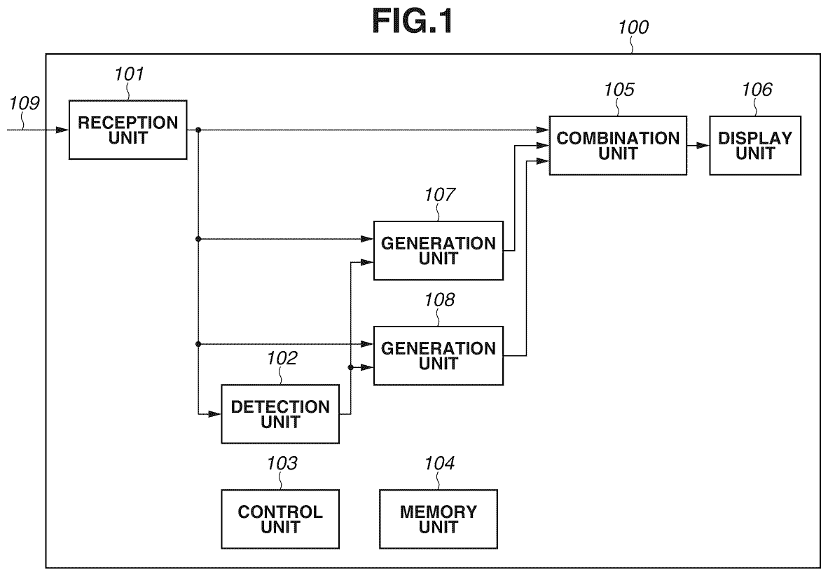

FIG. 1 is a block diagram illustrating a configuration example of a signal processing apparatus according to a first exemplary embodiment. A signal processing apparatus 100 of FIG. 1 includes a reception unit 101, a detection unit 102, a control unit 103, a memory unit 104, a combination unit 105, a display unit 106, a generation unit 107, and a generation unit 108.

The reception unit 101 acquires captured moving image data 109, and outputs the moving image data to the detection unit 102, the combination unit 105, the generation unit 107, and the generation unit 108. In the present exemplary embodiment, the reception unit 101 acquires image data from an external apparatus frame by frame of the moving image. The reception unit 101 then outputs the acquired image data to the units at the subsequent stages. Examples of the reception unit 101 include input terminals compliant with the Serial Digital Interface (SDI) and High-Definition Multimedia Interface (HDMI) (registered trademark) standards. The external apparatus is an imaging apparatus or a playback apparatus. The present exemplary embodiment deals with an example where an imaging apparatus 200 is connected. Details will be described below.

The detection unit 102 acquires the moving image data output from the reception unit 101, which includes area information, and outputs the acquired area information to the control unit 103, the generation unit 107, and the generation unit 108. The area information will be described below.

The control unit 103 controls the processing of various units of the signal processing apparatus 100. The control unit 103 is connected to the units with a control bus, whereas the control bus is omitted in the diagram to avoid complexity. An example of the control unit 103 is an arithmetic processing circuit that executes a program stored in the memory unit 104 and controls the processing of the blocks in the signal processing apparatus 100. In the present exemplary embodiment, the control unit 103 controls the combination unit 105 based on the area information output from the detection unit 102.

The memory unit 104 stores programs and parameters. The programs and parameters stored in the memory unit 104 are read and written by various blocks of the signal processing apparatus 100.

The combination unit 105 generates combined image data by combining the moving image data with a first waveform monitor that is a first indicator output from the generation unit 107 and a second waveform monitor that is a second indicator output from the generation unit 108, based on control output from the control unit 103. Combined moving image data is obtained by repeatedly generating combined image data. The combination unit 105 outputs the combined moving image data to the display unit 106.

The display unit 106 displays a moving image based on the combined moving image data output from the combination unit 105 on its display surface. Examples of the display unit 106 include a display panel including a liquid crystal panel and a backlight unit, and an organic electroluminescence (EL) display panel.

The generation unit 107 acquires the moving image data output from the reception unit 101 and the area information output from the detection unit 102, and generates a waveform monitor (first waveform monitor) for pixels specified as a virtual area by the area information in the moving image data. More specifically, the generation unit 107 extracts one frame of data from the moving image data, further extracts pixels specified as the virtual area from the one frame of data, and generates an analysis thereof as the first waveform monitor.

The generation unit 108 acquires the moving image data output from the reception unit 101 and the area information output from the detection unit 102, and generates a waveform monitor (second waveform monitor) for pixels specified as a real area by the area information in the moving image data. More specifically, the generation unit 108 extracts one frame of data from the moving image data, further extracts pixels specified as the real area from the one frame of data, and generates an analysis thereof as the second waveform monitor.

With the operations of the respective units being described, a procedure for displaying the first and second waveform monitors on the display unit 106 by integrating the operations will now be described. When the reception unit 101 receives the captured moving image data 109, the detection unit 102 extracts the area information from the moving image data and outputs the area information to the control unit 103, the generation unit 107, and the generation unit 108. The generation units 107 and 108 refer to the area information, and generate the first and second waveform monitors. The combination unit 105 combines the first and second waveform monitors with the moving image data, and outputs the resulting moving image data to the display unit 106 as the combined moving image data. The display unit 106 displays the combined moving imaged data including the first and second waveform monitors.

### Configuration of Imaging Apparatus

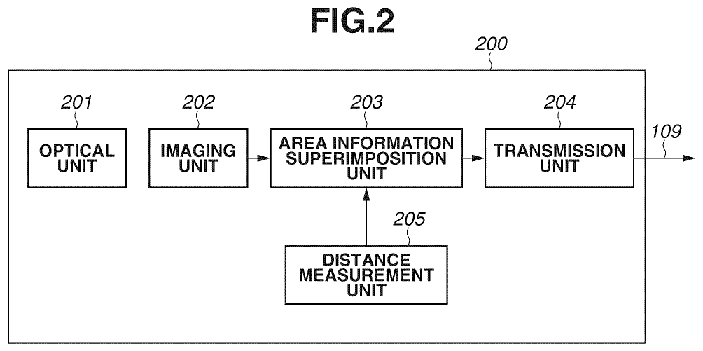

FIG. 2 is a block diagram illustrating a configuration example of the imaging apparatus 200 that generates the captured moving image data for the signal processing apparatus 100 according to the present exemplary embodiment to acquire. The imaging apparatus 200 of FIG. 2 includes an optical unit 201, an imaging unit 202, an area information superimposition unit 203, a transmission unit 204, and a distance measurement unit 205.

The optical unit 201 includes a lens and a focusing motor, and forms an image of an object to be imaged on the imaging unit 202. The imaging unit 202 includes an image sensor. The imaging unit 202 generates moving image data from the image formed by the optical unit 201, and outputs the moving image data to the area information superimposition unit 203. The area information superimposition unit 203 superimposes the area information on the moving image data, and outputs the resulting moving image data to the transmission unit 204. The area information will be described below. The transmission unit 204 transmits the moving image data received from the area information superimposition unit 203 as the captured moving image data 109. Examples of the transmission unit 204 include output terminals compliant with the SDI and HDMI standards. The distance measurement unit 205 measures the distance between the imaging apparatus 200 and the object to be imaged, with respect to each pixel on the image sensor. The distance measured by the distance measurement unit 205 is used to generate the area information. Details will be described below. A technique for measuring distance by disposing pixels for detecting a phase difference on the image sensor has been known, in which case the imaging unit 202 and the distance measurement unit 205 are integrally configured.

### Connection Example of Apparatuses

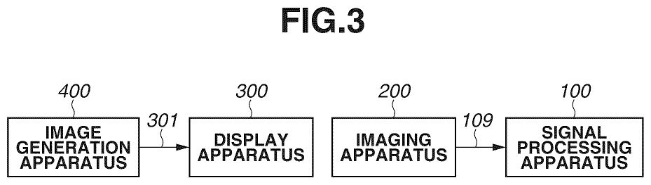

FIG. 3 is a block diagram illustrating a connection example of an image generation apparatus 400, a display apparatus 300, the imaging apparatus 200, and the signal processing apparatus 100. The image generation apparatus 400 stores previously captured moving image data inside, and plays back the previously captured moving image data to generate moving image data. The image generation apparatus 400 outputs the moving image data generated to the display apparatus 300 as generated moving image data 301. The display apparatus 300 is a light-emitting diode (LED) wall and serves as a background display for displaying the generated moving image data 301 (background video data). The imaging apparatus 200 outputs moving image data captured to the signal processing apparatus 100 as the captured moving image data 109.

### Outline of Imaging, from Bird's Eye Point of View

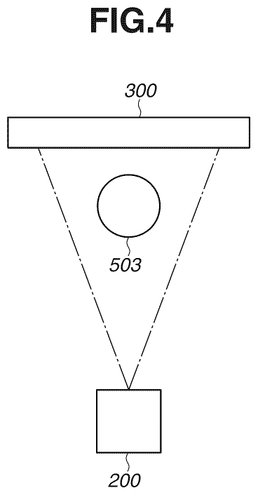

FIG. 4 is a diagram illustrating an outline of in-camera visual effects (VFX) imaging from a bird's eye point of view. An actor 503 performs between the display apparatus 300 and the imaging apparatus 200. The imaging apparatus 200 captures an image of the display apparatus 300 and the actor 503. The dot-dashed lines represent the angle of view of the optical unit 201. While FIG. 4 illustrates a case where the number of actors to be captured is one, there may be more than one actor or a studio set in addition to the actor(s). The display apparatus 300 displays a background video image, which the imaging apparatus 200 captures.

### Area Information for Identifying Real Area and Virtual Area

The area information will now be described. The area information refers to information for identifying whether each pixel belongs to a real area or a virtual area. The area information superimposition unit 203 attaches the area information, with pixels where the distance measured by the distance measurement unit 205 is substantially the same as the distance between the imaging apparatus 200 and the display apparatus 300 as a virtual area and the other pixels as a real area. The distance between the imaging apparatus 200 and the display apparatus 300 is measured by the user of the imaging apparatus 200 and the display apparatus 300, and set in the imaging apparatus 200. The area information is superimposed on the moving image data as metadata. Examples of the metadata include Ancillary (ANC) data standardized in SDI and InfoFrame standardized in HDMI. For ANC data, any given binary data can be superimposed on a horizontal blanking interval. While the specific method for superimposing the area information is not standardized, the area information can be superimposed by using ANC data in the following manner. In the present exemplary embodiment, a pixel belonging to a virtual area is expressed by a one-bit value of 1, and a pixel belonging to a real area is expressed by a one-bit value of 0. The values (1s and 0s) for as many pixels as are in one line are aggregated into a piece of data, which is superimposed as ANC data on the horizontal blanking interval of the corresponding line.

### Example of Captured Moving Image Data

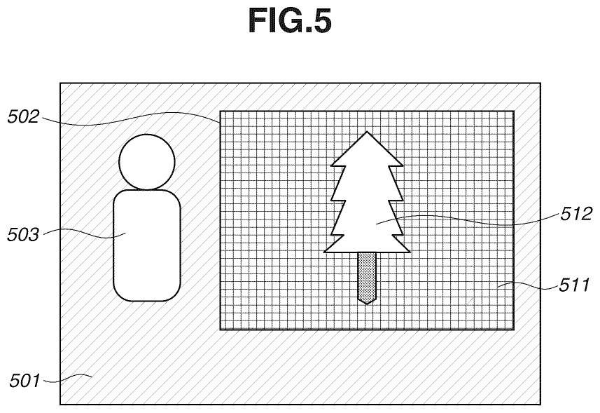

FIG. 5 is a diagram illustrating an example of the captured moving image data 109. The studio set includes a wall 501 and a window frame 502. The actor 503 is in front of the wall 501 of the studio set. An exterior scene 511 and a tree 512 are in the window frame 502. An image of the exterior scene 511 and the tree 512 is captured in advance and displayed on the display apparatus 300. The captured moving image data illustrated in FIG. 5 is obtained by capturing an image of the wall 501, the window frame 502, the actor 503, and the display apparatus 300 in such a state. The wall 501, the window frame 502, and the actor 503 belong to the real area. The exterior scene 511 and the tree 512 belong to the virtual area.

### Example of Combined Moving Image Data Displayed on Display Unit

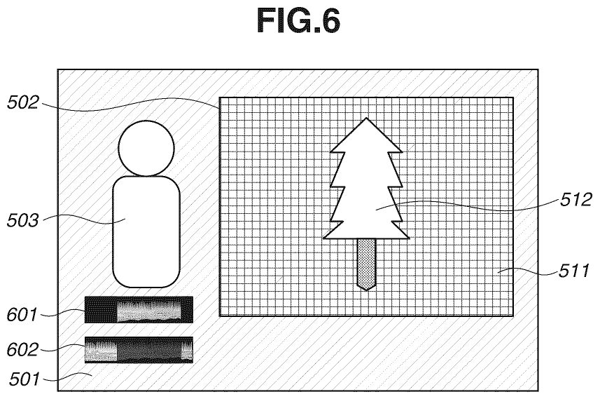

FIG. 6 is a diagram illustrating an example of the combined moving image data displayed on the display unit 106. A waveform monitor 601 is the first waveform monitor generated by the generation unit 107. The waveform monitor 601 visualizes characteristics analyzed from the virtual area of the captured moving image data illustrated in FIG. 5. A waveform monitor 602 is the second waveform monitor generated by the generation unit 108. The waveform monitor 602 visualizes characteristics analyzed from the real area of the captured moving image data illustrated in FIG. 5. In FIG. 6, elements denoted by the same reference numerals as in FIG. 5 are similar ones. The combined moving image data illustrated in FIG. 6 is obtained by combining the captured moving image data illustrated in FIG. 5 with the waveform monitors 601 and 602. The combined moving image data illustrated in FIG. 6 is displayed on the display unit 106.

### Effects of Present Exemplary Embodiment

According to the present exemplary embodiment, the user does not need to specify areas when separately analyzing the virtual area and the real area. Consulting the analyses of the first and second waveform monitors facilitates checking the brightness distributions in the virtual area and the real area and adjusting the exposure of the imaging apparatus 200 and the brightness of the LED wall.

### Modification

In the present exemplary embodiment, separate waveform monitors are described to be displayed for the virtual area and the real area. However, image analysis indicators including vectorscopes or chromaticity diagrams may be used instead of the waveform monitors. In the present exemplary embodiment, the combination unit 105 is described to combine the moving image data with the first and second waveform monitors and output the resulting moving image data to the display unit 106. However, the combination unit 105 may output the first and second waveform monitors to the display unit 106, and the display unit 106 may display the first and second waveform monitors. In such a case, the display unit 106 does not display the moving image data. In the present exemplary embodiment, the signal processing apparatus 100 is described to receive moving image data. However, the signal processing apparatus 100 may receive still image data. In the case of the moving image data, the reception unit 101 acquires image data frame by frame of the moving image. In the case of the still image, the reception unit 101 acquires new image data each time the still image data is updated.

A second exemplary embodiment of the present disclosure will now be described. Since the present exemplary embodiment is a modification of the first exemplary embodiment, differences from the first exemplary embodiment will mainly be described. A description of similarities to the first exemplary embodiment will be omitted where appropriate.

### Configuration of Signal Processing Apparatus

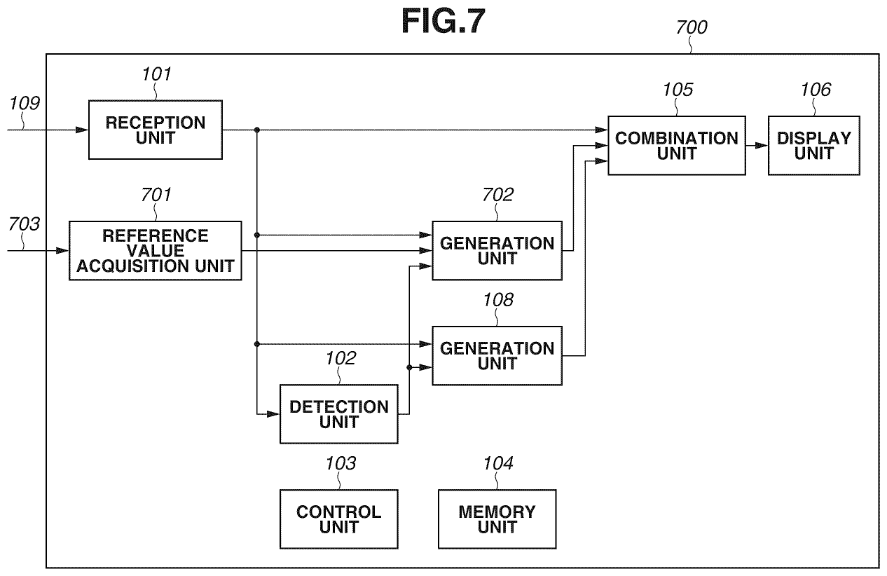

FIG. 7 is a block diagram illustrating a configuration example of a signal processing apparatus according to the present exemplary embodiment. A signal processing apparatus 700 of FIG. 7 includes a reception unit 101, a detection unit 102, a control unit 103, a memory unit 104, a combination unit 105, a display unit 106, a generation unit 108, a reference value acquisition unit 701, and a generation unit 702.

The reference value acquisition unit 701 acquires a reference value 703 from an external apparatus, which is a display apparatus 800. The reference value 703 is a value that serves as a reference for the brightness or color of the display apparatus 800. The display apparatus 800 will be described below. The generation unit 702 acquires moving image data output from the reception unit 101 and area information output from the detection unit 102, and generates a waveform monitor (first waveform monitor) for pixels specified as a virtual area by the area information in the moving image data. The generation unit 702 also draws the reference value of the display apparatus 800 acquired by the reference value acquisition unit 701 on the first waveform monitor. The reception unit 101, the detection unit 102, the control unit 103, the memory unit 104, the combination unit 105, the display unit 106, and the generation unit 108 are similar to those of the first exemplary embodiment.

### Configuration of Display Apparatus

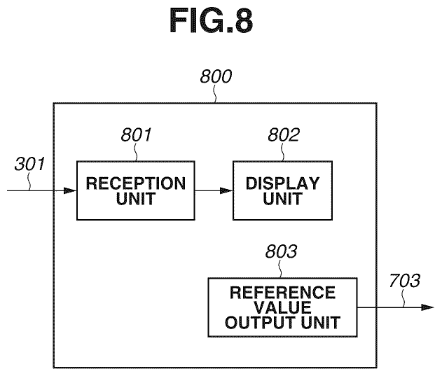

FIG. 8 is a block diagram illustrating a configuration example of the display apparatus 800 according to the present exemplary embodiment. The display apparatus 800 of FIG. 8 includes a reception unit 801, a display unit 802, and a reference value output unit 803. The reception unit 801 acquires generated moving image data 301 and outputs the moving image data to the display unit 802. Examples of the reception unit 801 include input terminals compliant with the SDI and HDMI (registered trademark) standards. The display unit 802 displays a moving image based on the moving image data output from the reception unit 801 on its display surface. The display unit 802 includes LEDs arranged in a matrix to constitute an LED wall. The reference value output unit 803 outputs the reference value 703 that serves as a reference for the brightness or color of the display apparatus 800. Examples of the reference value 703 as a brightness reference value may include at least one of the following: the maximum luminance of the display apparatus 800, the luminance of the display apparatus 800 for a reflectance of 18%, the luminance of the display apparatus 800 for a reflectance of 100%, a luminance of 200 nits, and a luminance of 203 nits. Examples of the reference value 703 as a color reference value may include: the chromaticity of achromatic color of the display apparatus 800, and the chromaticities of red, green, and blue constituting the color gamut of the display apparatus 800.

### Connection Example of Apparatuses

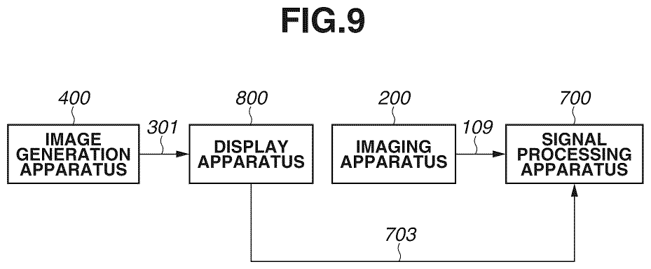

FIG. 9 is a block diagram illustrating a connection example of an image generation apparatus 400, the display apparatus 800, an imaging apparatus 200, and the signal processing apparatus 700. The image generation apparatus 400 outputs moving image data generated to the display apparatus 800 as the generated moving image data 301. The imaging apparatus 200 outputs moving image data captured to the signal processing apparatus 700 as captured moving image data 109. The display apparatus 800 outputs the reference value 703 to the signal processing apparatus 700. The display apparatus 800 and the signal processing apparatus 700 can communicate using a local area network (LAN), for example.

### Captured Moving Image Data and Combined Moving Image Data

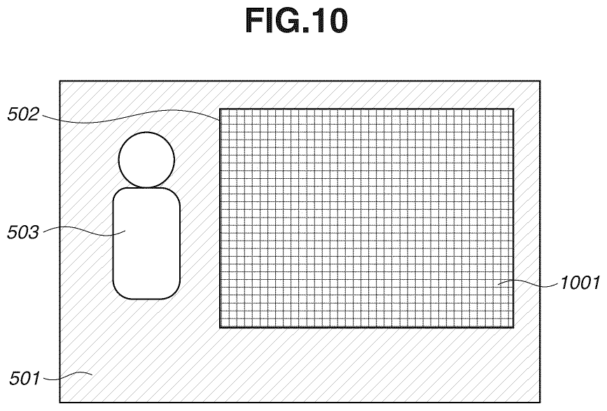

The case where the reference value 703 serves as a reference for brightness will now be described. FIG. 10 is a diagram illustrating an example of the captured moving image data 109. A wall 501, a window frame 502, and an actor 503 are similar to those of the first exemplary embodiment. The display apparatus 800 displays uniform achromatic color 1001. The captured moving image data illustrated in FIG. 10 is obtained by capturing an image of the wall 501, the window frame 502, the actor 503, and the display apparatus 800. The wall 501, the window frame 502, and the actor 503 belong to the real area. The achromatic color 1001 belongs to the virtual area.

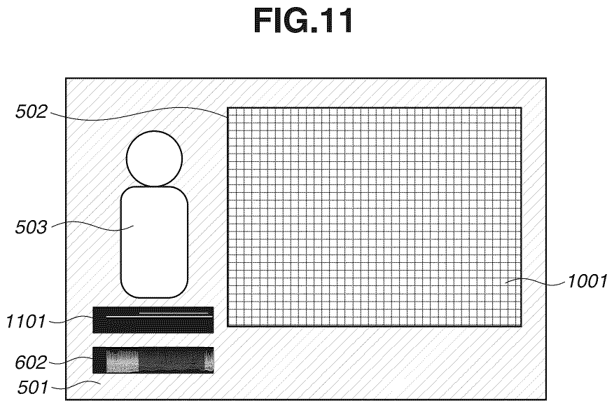

FIG. 11 is a diagram illustrating an example of the combined moving image data displayed on the display unit 106. A waveform monitor 1101 is the first waveform monitor generated by the generation unit 702. The waveform monitor 1101 visualizes characteristics analyzed from the virtual area of the captured moving image data illustrated in FIG. 10. A waveform monitor 602 is the second waveform monitor generated by the generation unit 108. The waveform monitor 602 visualizes characteristics analyzed from the real area of the captured moving image data illustrated in FIG. 10. Elements denoted by the same reference numerals as in FIG. 10 are similar to those of FIG. 10. The combined moving image data illustrated in FIG. 11 is obtained by combining the captured moving image data illustrated in FIG. 10 with the waveform monitors 1101 and 602.

### Drawing Example of First Waveform Monitor

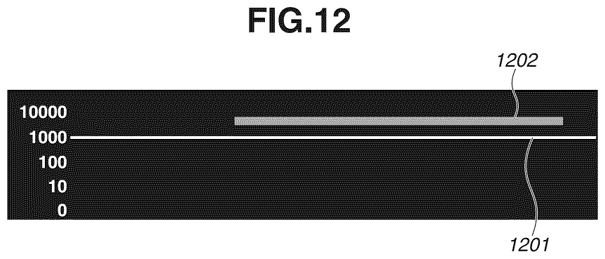

FIG. 12 illustrates a drawing example of the first waveform monitor. The vertical axis of the first waveform monitor indicates luminance, ranging from 0 to 10000 nits. When the reference value acquisition unit 701 acquires the maximum luminance of the display apparatus 800 as the reference value 703, and in a case where the reference value 703 has a value of 1000 nits, the generation unit 702 draws a line 1202 at the position of 1000 nits on the vertical axis. The luminance value of the achromatic color 1001 in the captured moving image data illustrated in FIG. 10 is further drawn as a line 1202. In the example illustrated in FIG. 12, the luminance value of the achromatic color 1001 is drawn above 1000 nits represented by the line 1201. This indicates an overexposed setting set in the imaging apparatus 200. While in the present exemplary embodiment the reference value is described to be the maximum luminance of 1000 nits, this is not restrictive.

The case where the reference value 703 serves as a reference for color will now be described. The generation unit 702 acquires the moving image data output from the reception unit 101 and the area information output from the detection unit 102, and generates a chromaticity diagram (first chromaticity diagram) for pixels specified as the virtual area by the area information in the moving image data. The generation unit 702 further draws the reference value 703 of the display apparatus 800 acquired by the reference value acquisition unit 701 on the first chromaticity diagram.

### Drawing Example of First Chromaticity Diagram

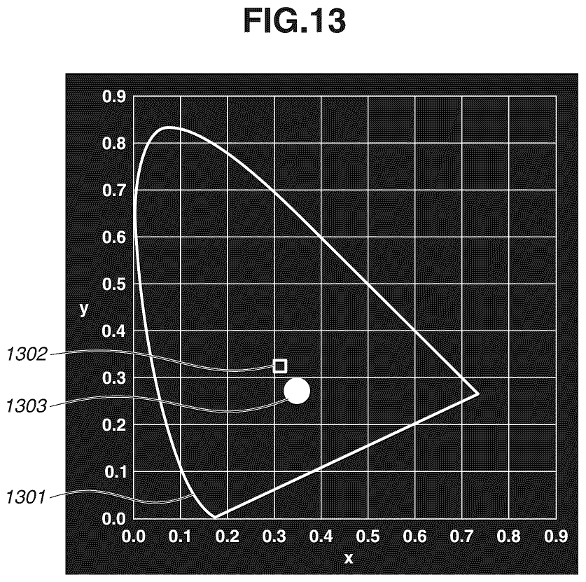

FIG. 13 illustrates a drawing example of the first chromaticity diagram. The region inside an area 1301 represents the entire range of visible light that a human can recognize. The horizontal axis of the first chromaticity diagram indicates x chromaticity, and the vertical axis y chromaticity. When the reference value acquisition unit 701 acquires the chromaticity of the achromatic color of the display apparatus 800 from the display apparatus 800 as the reference value 703, and in a case where the reference value 703 has a value of (x=0.3127, y=0.3290), the generation unit 702 draws a marker 1302 at the corresponding position on the chromaticity diagram. The achromatic color 1001 of the captured moving image data illustrated in FIG. 10 is drawn as a marker 1303. In the example illustrated in FIG. 13, the achromatic color 1001 is located at a position (relatively reddish position) where x is greater and y is smaller than the chromaticity (x=0.3127, y=0.3290) indicated by the marker 1302. This indicates a reddish setting set in the imaging apparatus 200 in comparison with what is expected. While the reference value (x=0.3127, y=0.3290) according to the present exemplary embodiment is for the case of using achromatic color D65, reference values of other standard light sources may be employed.

### Effects of Present Exemplary Embodiment

According to the present exemplary embodiment, a deviation in brightness or color between the reference value of the display apparatus 800 and the captured moving image data can be intuitively understood. For example, in the example illustrated in FIG. 12, the user knows that the captured moving image data is brighter than the reference value. This suggests that the imaging apparatus 200 is set to be overexposed compared to the reference value of the display apparatus 800 (in other words, an object that is expected to exhibit reference white luminance after in-camera VFX fails to be captured with the reference white luminance). In the example illustrated in FIG. 13, the user knows that the captured moving image data is reddish compared to the reference value. This suggests that the setting of the imaging apparatus 200 is reddish compared to the reference value of the display apparatus 800.

A third exemplary embodiment of the present disclosure will now be described. Since the present exemplary embodiment is a modification of the first exemplary embodiment, differences from the first exemplary embodiment will mainly be described. A description of similarities to the first exemplary embodiment will be omitted where appropriate.

### Configuration of Signal Processing Apparatus

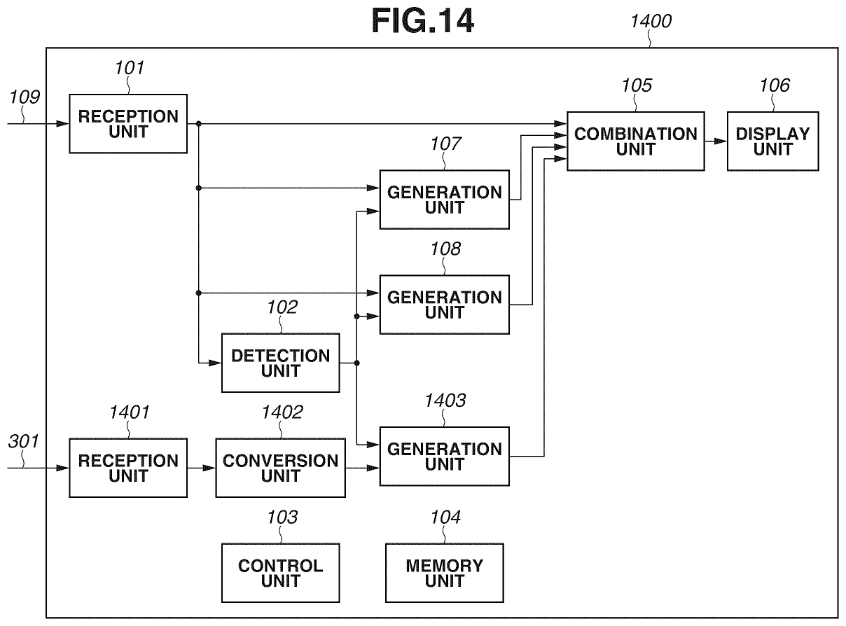

FIG. 14 is a block diagram illustrating a configuration example of a signal processing apparatus according to the present exemplary embodiment. A signal processing apparatus 1400 of FIG. 14 includes a reception unit 101, a detection unit 102, a control unit 103, a memory unit 104, a combination unit 105, a display unit 106, a generation unit 107, a generation unit 108, a reception unit 1401, a conversion unit 1402, and a generation unit 1403. The reception unit 101, the detection unit 102, the control unit 103, the memory unit 104, the combination unit 105, the display unit 106, the generation unit 107, and the generation unit 108 are similar to those of the first exemplary embodiment. A description thereof will thus be omitted.

The reception unit 1401 acquires generated moving image data 301 from an external apparatus, which is an image generation apparatus 400, and outputs the moving image data to the conversion unit 1402.

The conversion unit 1402 converts the moving image data and outputs the converted moving image data to the generation unit 1403. Here, the conversion unit 1402 applies arithmetic processing to the generated moving image data 301. The arithmetic processing is intended to convert the generated moving image data 301 into moving image data where a display apparatus 300 displaying the generated moving image data 301 is viewed from the position of an imaging apparatus 200, with the optical axis of the imaging apparatus 200 as the line of sight and the imaging range of the imaging apparatus 200 as the field of view. In the present exemplary embodiment, four endpoints of the imaging range on the imaging surface of the imaging apparatus 200 are (V0, V1, V2, V3), and four points corresponding to the four endpoints (V0, V1, V2, V3) on the display surface of the display apparatus 300 are (D0, D1, D2, D3). The conversion processing of the conversion unit 1402 can be implemented by projective transformation discussed in Japanese Patent Application Laid-Open No. 2011-48415. Specifically, the projective transformation is from the four points (D0, D1, D2, D3) of the display apparatus 300 to the four endpoints (V0, V1, V2, V3) of the imaging apparatus 200. The image generation apparatus 400 manages the four endpoints (V0, V1, V2, V3) and the four points (D0, D1, D2, D3) for use in the arithmetic processing, and outputs the four endpoints (V0, V1, V2, V3) and the four points (D0, D1, D2, D3) as superimposed on the generated moving image data 301. The conversion unit 1402 refers to the generated moving image data 301 via the reception unit 1401.

The generation unit 1403 acquires the moving image data output from the conversion unit 1402 and the area information output from the detection unit 102. The generation unit 1403 then generates a waveform monitor (third waveform monitor) that is an indicator for the pixels specified as the virtual area by the area information in the moving image data. Due to the conversion by the conversion unit 1402, the moving image data output from the conversion unit 1402 and the area information can be handled in the coordinate system on the imaging surface of the imaging apparatus 200.

### Connection Example of Apparatuses

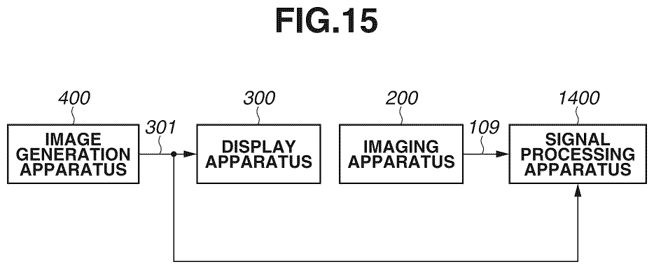

FIG. 15 is a block diagram illustrating a connection example of the image generation apparatus 400, the display apparatus 300, the imaging apparatus 200, and the signal processing apparatus 1400. The image generation apparatus 400 outputs moving image data generated to the display apparatus 300 and the signal processing apparatus 1400 as the generated moving image data 301. The imaging apparatus 200 outputs moving image data captured to the signal processing apparatus 1400 as captured moving image data 109.

### Example of Combined Moving Image Data Displayed on Display Unit

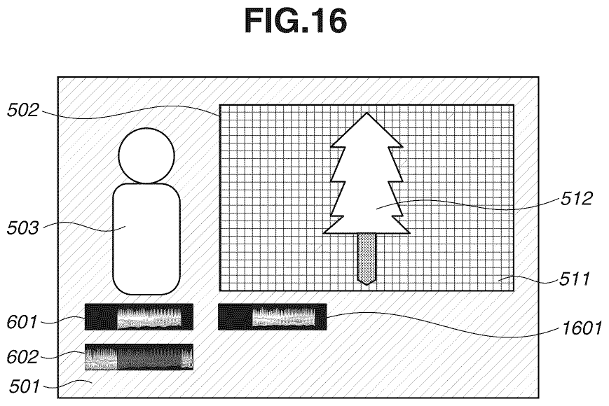

FIG. 16 is a diagram illustrating an example of combined moving image data displayed on the display unit 106. A waveform monitor 601 is the first waveform monitor generated by the generation unit 107. The waveform monitor 601 visualizes characteristics analyzed from the virtual area of the captured moving image data illustrated in FIG. 5. A waveform monitor 602 is the second waveform monitor generated by the generation unit 108. The waveform monitor 602 visualizes characteristics analyzed from the real area of the captured moving image data illustrated in FIG. 5. A waveform monitor 1601 is the third waveform monitor, or third indicator, generated by the generation unit 1403. The waveform monitor 1601 visualizes characteristics obtained by extracting the virtual area from the moving image data output from the conversion unit 1402 based on the area information output from the detection unit 102 and analyzing the virtual area. In FIG. 16, elements denoted by the same reference numerals as in FIG. 5 are similar ones. The combined moving image data illustrated in FIG. 16 is obtained by combining the captured moving image data illustrated in FIG. 5 with the waveform monitors 601, 602, and 1601.

### Effects of Present Exemplary Embodiment

According to the present exemplary embodiment, a deviation in brightness between the generated moving image data and the captured moving image data can be intuitively understood. For example, in a case where the analysis of the first waveform monitor is brighter than the analysis of the third waveform monitor, the user knows that the captured moving image data is brighter than the generated moving image data. This suggests that the imaging apparatus 200 is set to be overexposed. Conversely, in a case where the analysis of the first waveform monitor is dimmer than the analysis of the third waveform monitor, the user knows that the captured moving image data is dimmer than the generated moving image data. This suggests that the imaging apparatus 200 is set to be underexposed.

A fourth exemplary embodiment of the present disclosure will now be described. Since the present exemplary embodiment is a modification of the first exemplary embodiment, differences from the first exemplary embodiment will mainly be described. A description of similarities to the first exemplary embodiment will be omitted where appropriate.

### Configuration of Signal Processing Apparatus

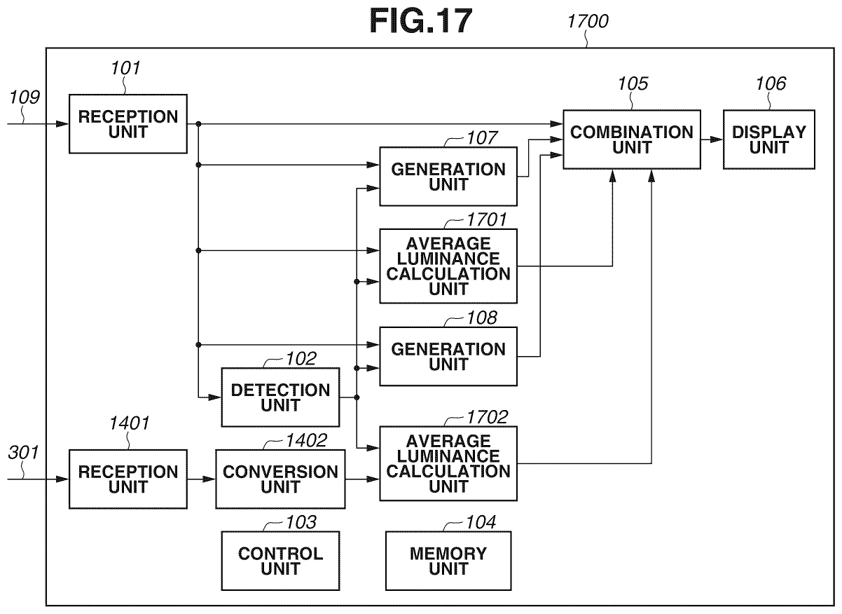

FIG. 17 is a block diagram illustrating a configuration example of a signal processing apparatus according to the present exemplary embodiment. A signal processing apparatus 1700 of FIG. 17 includes a reception unit 101, a detection unit 102, a control unit 103, a memory unit 104, a combination unit 105, a display unit 106, a generation unit 107, a generation unit 108, a reception unit 1401, a conversion unit 1402, an average luminance calculation unit 1701, and an average luminance calculation unit 1702. The reception unit 101, the detection unit 102, the control unit 103, the memory unit 104, the combination unit 105, the display unit 106, the generation unit 107, and the generation unit 108 are similar to those of the first exemplary embodiment. The reception unit 1401 and the conversion unit 1402 are similar to those of the third exemplary embodiment.

The average luminance calculation unit 1701 calculates the average luminance of the virtual area from the moving image data output from the reception unit 101 based on the area information output from the detection unit 102, and draws the average luminance on the first waveform monitor.

The average luminance calculation unit 1702 calculates the average luminance of the virtual area from the moving image data output from the reception unit 1401 based on the area information output from the detection unit 102, and draws the average luminance on the first waveform monitor.

### Connection Example of Apparatuses

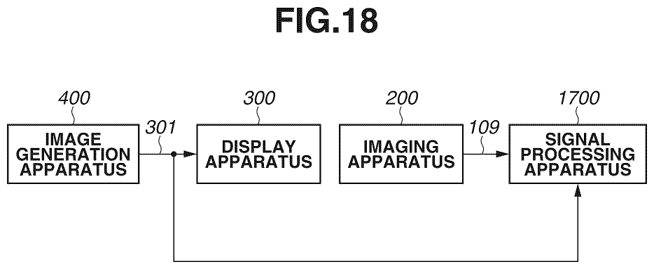

FIG. 18 is a block diagram illustrating a connection example of an image generation apparatus 400, a display apparatus 300, an imaging apparatus 200, and the signal processing apparatus 1700. The image generation apparatus 400 outputs moving image data generated to the display apparatus 300 and the signal processing apparatus 1700 as generated moving image data 301. The imaging apparatus 200 outputs moving image data captured to the signal processing apparatus 1700 as captured moving image data 109.

### Example of Combined Moving Image Data Displayed on Display Unit

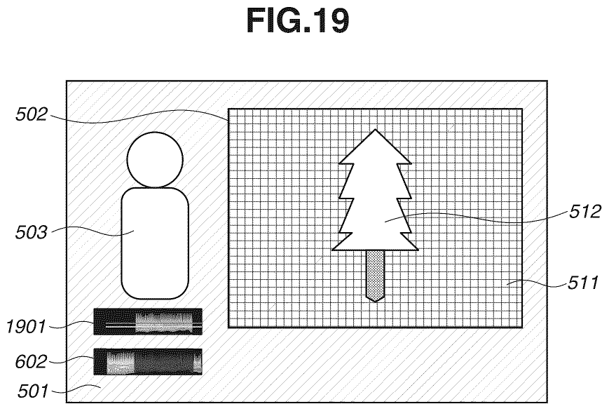

FIG. 19 is a diagram illustrating an example of combined moving image data displayed on the display unit 106. A waveform monitor 1901 is the first waveform monitor, and visualizes characteristics analyzed from the virtual area of the captured moving image data illustrated in FIG. 5. A waveform monitor 602 is the second waveform monitor, and visualizes characteristics analyzed from the real area of the captured moving image data illustrated in FIG. 5.

Elements denoted by the same reference numerals as in FIG. 5 are similar to those of FIG. 5. The combined moving image data illustrated in FIG. 19 is obtained by combining the captured moving image data illustrated in FIG. 5 with the waveform monitors 1901 and 602.

### Drawing Example of First Waveform Monitor

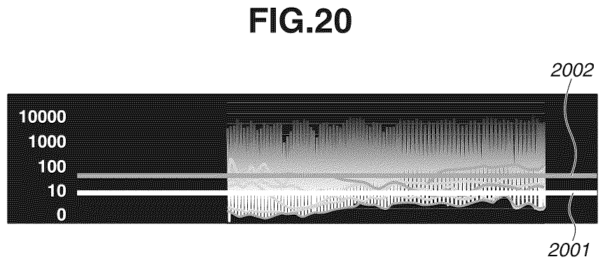

FIG. 20 illustrates a drawing example of the first waveform monitor. An average luminance 2001 indicates the average luminance of the virtual area of the captured moving image data 109, calculated by the average luminance calculation unit 1701. An average luminance 2002 indicates the average luminance of the virtual area of the generated moving image data 301, calculated by the average luminance calculation unit 1702. The average luminance 2001 and the average luminance 2002 are desirably drawn in different modes (brightnesses, colors, or thicknesses). In the example illustrated in FIG. 20, the average luminance 2001 and the average luminance 2002 differ in brightness.

In the example illustrated in FIG. 20, the average luminance 2001 is dimmer than the average luminance 2002. This suggests that the imaging apparatus 200 is set to be underexposed.

### Effects of Present Exemplary Embodiment

According to the present exemplary embodiment, a setting error of the imaging apparatus 200 can be intuitively understood from the difference between the average luminance 2001 and the average luminance 2002.

In the first exemplary embodiment, the first waveform monitor and the second waveform monitor are described to be displayed.

A fifth exemplary embodiment deals with an example where whether to display the first and second waveform monitors or only the first waveform monitor is switched based on the user's setting operation and the presence or absence of area information.

### Configuration of Signal Processing Apparatus

A signal processing apparatus 100 includes an additional unit for the user to perform setting operations. Examples include operation keys and an on-screen display (OSD) menu. As a waveform monitor display setting, the signal processing apparatus 100 has three setting values “normal”, “auto”, and “extended”, which the user can select.

### Control Procedure of Signal Processing Apparatus

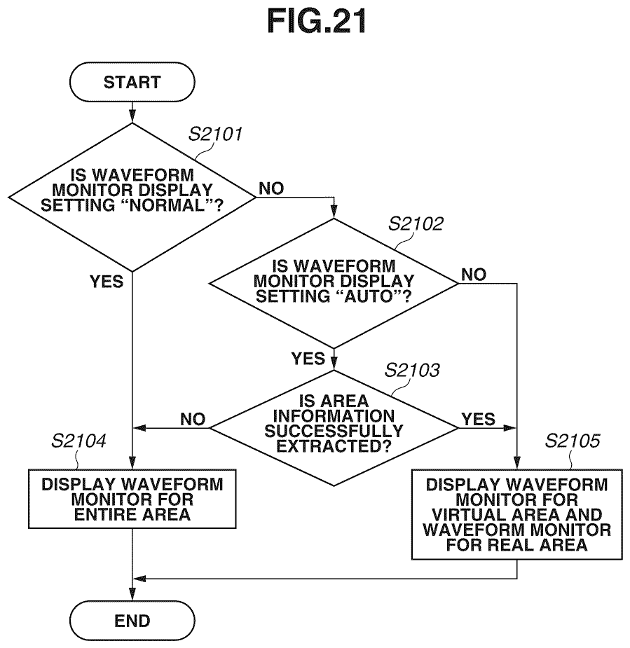

FIG. 21 is a flowchart illustrating a control procedure of the signal processing apparatus 100. A control unit 103 executes the control procedure each time a reception unit 101 acquires one frame of moving image data.

In step S2101, in a case where the waveform monitor display setting is “normal” (YES in step S2101), the processing proceeds to step S2104. In a case where the waveform monitor display setting is not “normal” (NO in step S2101), the processing proceeds to step S2102. In step S2102, in a case where the waveform monitor display setting is “auto” (YES in step S2102), the processing proceeds to step S2103. In a case where the waveform monitor display setting is not “auto” (NO in step S2103), the processing proceeds to step S2105. In summary, the operation of steps S2101 and S2102 is as follows: In a case where the waveform monitor display setting is “normal”, the processing proceeds to step S2104; in a case where the waveform monitor display setting is “auto”, the processing proceeds to step S2103; and in a case where the waveform monitor display setting is “extended”, the processing proceeds to step S2105. In step S2103, in a case where the detection unit 102 successfully extracts area information from the moving image data (YES in step S2103), the processing proceeds to step S2105. In a case where the detection unit 102 extracts no area information from the moving image data (NO in step S2103), the processing proceeds to step S2104. Area information is superimposed on the moving image data as ANC data in SDI or InfoFrame in HDMI. Area information is therefore unable to be extracted in a case where the external apparatus does not superimpose the area information.

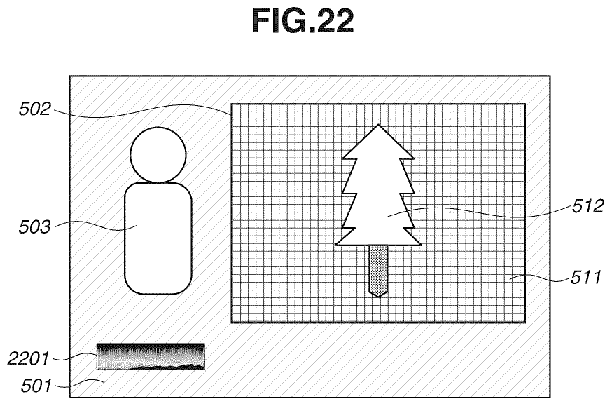

In step S2104, the display unit 106 displays a waveform monitor for the entire area of the moving image data. Here, the generation unit 107 generates the waveform monitor for the entire area of the moving image data acquired from the reception unit 101 as the first waveform monitor. The control unit 103 combines the first waveform monitor and the moving image data, and outputs the resulting moving image data to the display unit 106 as the combined moving image data. The display unit 106 displays the combined moving image data including the first waveform monitor. FIG. 22 is a diagram illustrating a display example of the combined moving image data when a waveform monitor for the entire area of the moving image data is displayed. A waveform monitor 2201 is the first waveform monitor generated by the generation unit 107. The waveform monitor 2201 visualizes characteristics analyzed from the entire area of the moving image data. Elements denoted by the same reference numerals as in FIG. 5 are similar to those of FIG. 5. The combined moving image data illustrated in FIG. 22 is obtained by combining the moving image data illustrated in FIG. 5 with the waveform monitor 2201.

In step S2105, the display unit 106 displays the first waveform monitor corresponding to the virtual area of the moving image data and the second waveform monitor corresponding to the real area. Since the display is similar to the display of the first exemplary embodiment, details will be omitted.

### Modification

In the present exemplary embodiment, the first waveform monitor corresponding to the virtual area of the moving image data and the second waveform monitor corresponding to the real area are described to be displayed when the area information is successfully extracted from the moving image data. Moreover, a single waveform monitor for the entire area of the moving image data is described to be displayed when the area information is not successfully extracted from the moving image data. However, the waveform monitor for the entire area of the moving image data may be additionally displayed when the area information is successfully extracted from the moving image data. In such a case, the display apparatus includes an additional generation unit that generates the waveform monitor.

### Effects of Present Exemplary Embodiment

According to the present exemplary embodiment, the second waveform monitor can be displayed as appropriate in scenes where the second waveform monitor is desirably displayed. This improves usability.

### Configuration of Signal Processing Apparatus

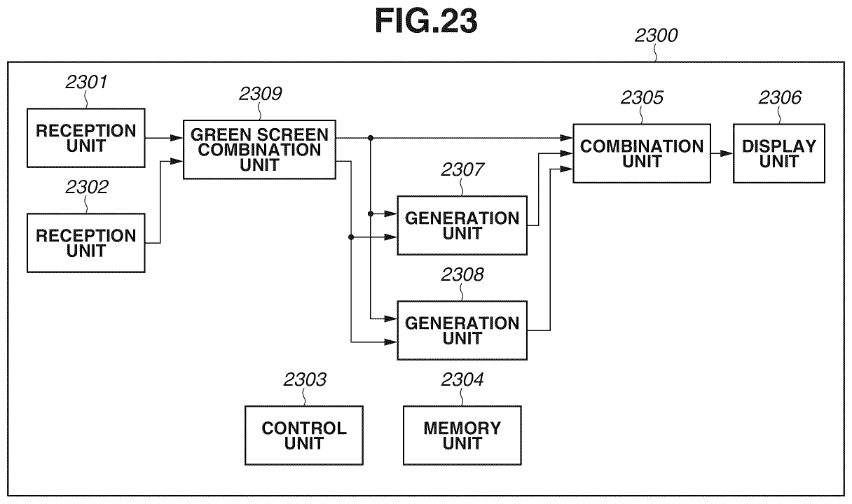

FIG. 23 is a block diagram illustrating a configuration example of a signal processing apparatus according to a sixth exemplary embodiment. An image display apparatus (signal processing apparatus) 2300 includes a reception unit 2301, a reception unit 2302, a green screen combination unit 2309, a control unit 2303, a memory unit 2304, a combination unit 2305, a display unit 2306, a generation unit 2307, and a generation unit 2308.

The reception unit 2301 acquires first input moving image data and outputs the first input moving image data to the green screen combination unit 2309. The first input moving image data is a moving image obtained by capturing an actor or actors performing in front of a green screen.

The reception unit 2302 acquires second input moving image data and outputs the second input moving image data to the green screen combination unit 2309. The second input moving image data is a moving image captured separate from the first input moving image data. In the present exemplary embodiment, the reception unit 2301 and the reception unit 2302 acquire the image data from external apparatuses frame by frame of the moving images. Examples of the reception units 2301 and 2302 include input terminals compliant with the SDI and HDMI standards. The external apparatuses are imaging apparatuses or playback apparatuses.

The green screen combination unit 2309 combines the first input moving image data acquired from the reception unit 2301 and the second input moving image data acquired from the reception unit 2302 to generate moving image data, and outputs the moving image data to the combination unit 2305, the generation unit 2307, and the generation unit 2308. The moving image data here includes pixel values acquired from the second input moving image data for pixels that are green in the first input moving image data, and pixel values acquired from the first input moving image data for the other pixels. The green screen combination unit 2309 also generates area information and outputs the area information to the control unit 2303, the generation unit 2307, and the generation unit 2308. Here, the area information refers to information for identifying pixels that are green in the first input moving image data as a virtual area and the other pixels as a real area. The green screen combination unit 2309 can adjust the image quality (brightness or color) of the first input moving image data and the second input moving image data separately.

The control unit 2303 controls the processing of various units of the image display apparatus 2300. The control unit 2303 is connected to the units with a control bus, whereas the control bus is omitted in the diagram to avoid complexity. An example of the control unit 2303 is an arithmetic processing circuit that executes a program stored in the memory unit 2304 and controls the processing of the blocks in the image display apparatus 2300. In the present exemplary embodiment, the control unit 2303 controls the combination unit 2305 based on the area information output from the green screen combination unit 2309.

The memory unit 2304 stores programs and parameters. The programs and parameters stored in the memory unit 2304 are read and written by various blocks of the image display apparatus 2300.

The combination unit 2305 generates combined moving image data by combining the moving image data with a first waveform monitor output from the generation unit 2307 and a second waveform monitor output from the generation unit 2308 based on control output from the control unit 2303. The combination unit 2305 then outputs the combined moving image data to the display unit 2306.

The display unit 2306 displays a moving image based on the combined moving image data output from the combination unit 2305 on its display surface. Examples of the display unit 2306 include a liquid crystal display unit including a liquid crystal panel and a backlight unit, and an organic EL display panel.

The generation unit 2307 obtains the moving image data output from the green screen combination unit 2309 and the area information output from the green screen combination unit 2309. The generation unit 2307 then generates a waveform monitor (first waveform monitor) for pixels specified as a virtual area by the area information in the moving image data. More specifically, the generation unit 2307 extracts one frame of data from the moving image data, further extracts the pixels specified as the virtual area from the data, and generates an analysis thereof as the first waveform monitor.

The generation unit 2308 obtains the moving image data output from the green screen combination unit 2309 and the area information output from the green screen combination unit 2309. The generation unit 2308 then generates a waveform monitor (second waveform monitor) for pixels specified as a real area by the area information in the moving image data. More specifically, the generation unit 2308 extracts one frame of data from the moving image data, further extracts the pixels specified as the real area from the data, and generates an analysis thereof as the second waveform monitor.

With the operations of the respective units being described, a procedure for displaying the first waveform monitor and the second waveform monitor on the display unit 2306 by integrating the operations will now be described. The reception unit 2301 receives the first input moving image data, and the reception unit 2302 receives the second input moving image data. The green screen combination unit 2309 combines the first input moving image data and the second input moving image data to generate moving image data and area information. The green screen combination unit 2309 then outputs the moving image data and the area information to the control unit 2303, the generation unit 2307, and the generation unit 2308. The generation units 2307 and 2308 refer to the area information and generate the first and second waveform monitors. The combination unit 2305 combines the first and second waveform monitors with the moving image data, and outputs the resulting moving image data to the display unit 2306 as combined moving image data. The display unit 2306 displays the combined moving image data including the first waveform monitor and the second waveform monitor.

### Example of First and Second Input Moving Image Data

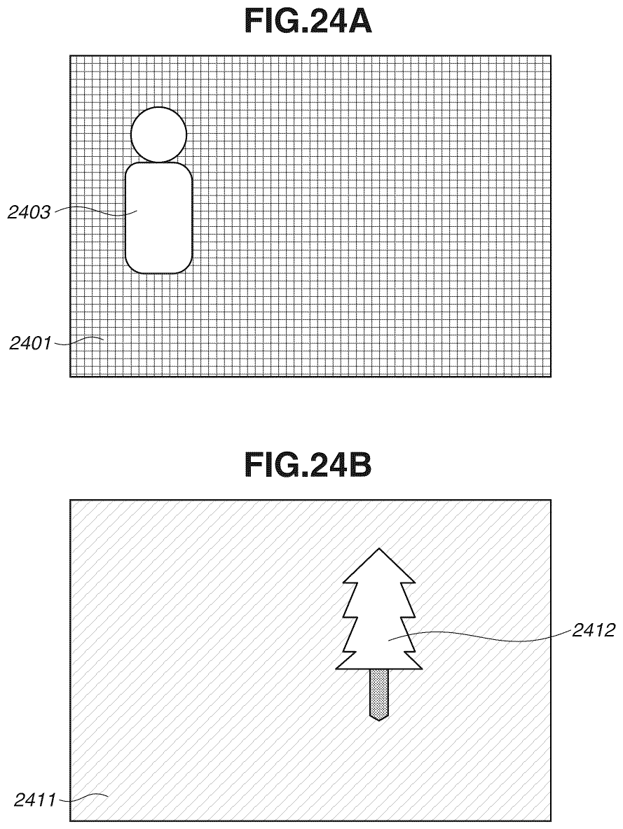

FIG. 24A is a diagram illustrating an example of the first input moving image data. An actor 2403 is in front of a green screen 2401.

FIG. 24B is a diagram illustrating an example of the second input moving image data. This moving image is captured to include an exterior scene 2411 and a tree 2412.

### Example of Moving Image Data

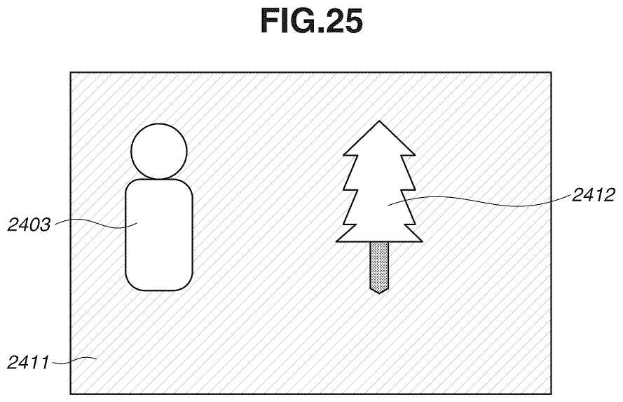

FIG. 25 is a diagram illustrating an example of the moving image data. The actor 2403 is cut out from the first input moving image data illustrated in FIG. 24A, and combined with (superimposed on) the second input moving image data illustrated in FIG. 24B. The moving image data thus includes the actor 2403, the exterior scene 2411, and the tree 2412.

### Example of Combined Moving Image Data Displayed on Display Unit

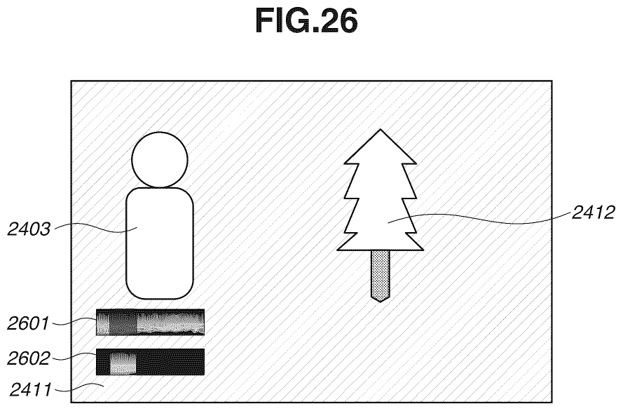

FIG. 26 is a diagram illustrating an example of the combined moving image data displayed on the display unit 2306. A waveform monitor 2601 is the first waveform monitor generated by the generation unit 2307. The waveform monitor 2601 visualizes characteristics analyzed from the virtual area of the moving image data illustrated in FIG. 25. A waveform monitor 2602 is the second waveform monitor generated by the generation unit 2308. The waveform monitor 2602 visualizes characteristics analyzed from the real area of the moving image data illustrated in FIG. 25. Elements denoted by the same reference numerals as in FIG. 25 are similar to those of FIG. 25. The combined moving image data illustrated in FIG. 26 is obtained by combining the moving image data illustrated in FIG. 25 with the waveform monitors 2601 and 2602.

### Effects of the Present Exemplary Embodiment

According to the present exemplary embodiment, the user does not need to specify areas when separately analyzing the virtual area and the real area. The brightness distributions of the virtual and real areas can be checked by referring to the analyses of the first and second waveform monitors. This also facilitates adjusting differences in image quality between the first input moving image data and the second input moving image data (for example, making the brightnesses of the first input moving image data and the second input moving image data substantially uniform) during image quality adjustment for green screen combination.

A seventh exemplary embodiment of the present disclosure will now be described. Since the present disclosure is a modification of the first exemplary embodiment, differences from the first exemplary embodiment will mainly be described. A description of similarities to the first exemplary embodiment will be omitted where appropriate. In the first exemplary embodiment, the combined moving image data is displayed by combining the waveform monitors with the moving image data. In the present exemplary embodiment, combined moving image data is displayed by combining frequency analysis graphs with the moving image data.

### Analysis of Frequency Characteristics of Image

In the present exemplary embodiment, levels are determined at regular frequency intervals by fast Fourier transform (FFT) using the pixel signals of the moving image data. A frequency analysis graph based on the frequency characteristics of the image can be obtained by determining a number i, a frequency freq(i), and a level levelLA(i) in order from the lower frequencies.

### Configuration of Signal Processing Apparatus

A generation unit 107 obtains moving image data output from a reception unit 101 and area information output from a detection unit 102, and displays a frequency analysis graph for pixels specified as a virtual area by the area information in the moving image data.

A generation unit 108 obtains the moving image output from the reception unit 101 and the area information output from the detection unit 102, and displays a frequency analysis graph for pixels specified as a real area by the area information in the moving image data.

The reception unit 101, the detection unit 102, a control unit 103, a memory unit 104, a combination unit 105, and a display unit 106 are similar to those of the first exemplary embodiment.

### Example of Combined Moving Image Data Displayed on Display Unit

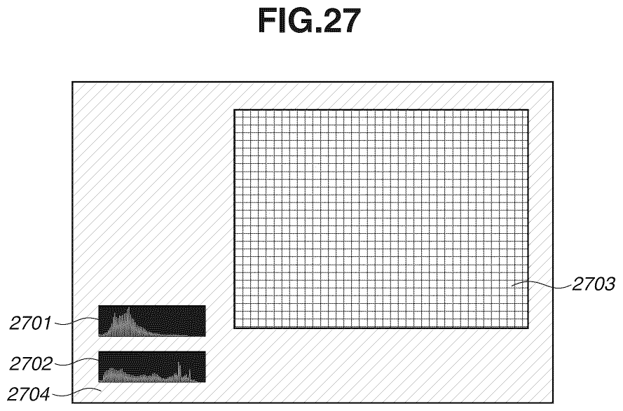

FIG. 27 is a diagram illustrating an example of combined moving image data displayed on the display unit 106. A frequency analysis graph 2701 is the frequency analysis graph generated by the generation unit 107. The frequency analysis graph 2701 is a graph that visualizes spatial frequency characteristics analyzed from the virtual area of the captured moving image data. A frequency analysis graph 2702 is the frequency analysis graph generated by the generation unit 108. The frequency analysis graph 2702 is a graph that visualizes spatial frequency characteristics analyzed from the real area of the captured moving image data. An area 2703 is the virtual area of the captured moving image data. An area 2704 is the real area of the captured moving image data. Specific image patterns are omitted.

The horizontal axes of the frequency analysis graphs 2701 and 2702 indicate spatial frequency, with lower frequencies to the left and higher frequencies to the right. The vertical axes indicate the count, with larger counts at the top and smaller counts at the bottom.

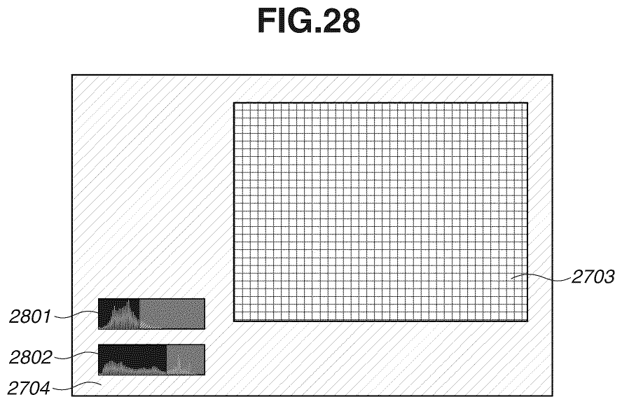

An example different from that illustrated in FIG. 27 will be described. FIG. 28 is a diagram illustrating an example of the combined moving image data displayed on the display unit 106. A frequency analysis graph 2801 visualizes characteristics analyzed from the virtual area of the captured moving image data. A frequency analysis graph 2802 visualizes characteristics analyzed from the real area of the captured moving image data.

The frequency analysis graph 2801 is a graph drawn using a first mode for a domain where the spatial frequency is lower than a first threshold, and a second mode for a domain where the spatial frequency is higher than the first threshold. In the example illustrated in FIG. 28, the second mode uses lighter gray than the first mode. The similar applies to the frequency analysis graph 2802. Note that the first threshold for the spatial frequency at which the first and second are switched in the frequency analysis graph 2801 corresponding to the virtual area is lower than a second threshold in the frequency analysis graph 2802 corresponding to the real area. For example, the spatial frequency at which the first and second modes are switched in the frequency analysis graph 2802 corresponding to the real area is ¼ of the sampling frequency. The spatial frequency at which the first and second modes are switched in the frequency analysis graph 2801 corresponding to the virtual area is 1/16 of the sampling frequency. However, this is not restrictive. The user of the signal processing apparatus 100 may set the frequencies via a not-illustrated operation unit.

In a case where the frequency analysis graph 2801 corresponding to the virtual area includes a count drawn in the second mode, it indicates the presence of pixels where the virtual area is in focus. In a case where the frequency analysis graph 2802 corresponding to the virtual area includes a count drawn in the second mode, it indicates the presence of pixels where the real area is in focus.

### Effects of the Present Exemplary Embodiment

According to the present exemplary embodiment, the user does not need to specify areas when separately analyzing the virtual area and the real area. Consulting the frequency analysis graphs of the virtual area and the real area facilitates separately checking the in-focus states of the virtual area and the real area (whether the areas are in focus).

The moving image data of the virtual area is generated by capturing an image of the LED wall, and thus can cause moiré due to the pixels of the LED walls. Moiré caused by the LED wall coming into focus against the user's intention can be reduced by adjusting the focus while referring to the frequency analysis graph of the virtual area.

Moreover, since the frequency analysis graph of the virtual area starts to be drawn in the second mode at a spatial frequency lower than the spatial frequency of the real area, the user can easily find out that the LED fall is in focus. This can further reduce moiré caused by the LED wall coming into focus against the user's intention.

An eighth exemplary embodiment of the present disclosure will now be described. Since the present exemplary embodiment is a modification of the first exemplary embodiment, differences from the first exemplary embodiment will mainly be described. A description of similarities to the first exemplary embodiment will be omitted where appropriate. In the present exemplary embodiment, a distance graph is displayed in addition to the waveform monitors according to the first exemplary embodiment when the combined moving image data is displayed.

### Processing of Imaging Apparatus

An imaging apparatus 200 superimposes a distance from the imaging apparatus 200 to a display apparatus 300, measured by the user and set in the imaging apparatus 200, on captured moving image data 109. In a case where the optical axis of the imaging apparatus 200 is not perpendicular to the display surface of the display apparatus 300, the user measures the smallest and largest values of the distance from the imaging apparatus 200 to the display apparatus 300 and sets the values in the imaging apparatus 200 as a range of distances. The imaging apparatus 200 superimposes the range of distances on the captured moving image data 109.

The imaging apparatus 200 measures the distance from the imaging apparatus 200 to an actor 503, and superimposes the distance on the captured moving image data 109. As the distance from the imaging apparatus 200 to the actor 503, the imaging apparatus 200 superimposes a distance corresponding to the area of the captured moving image data 109 set by the user via a not-illustrated operation unit among distances measured by the distance measurement unit 205 from the imaging apparatus 200 to objects to be imaged. In a case where the distance of the user-specified area varies pixel by pixel within the area, the imaging apparatus 200 superimposes the smallest and largest values of the distance as a range of distances. The user sets the area where the actor 503 is captured in the image.

The imaging apparatus 200 superimposes a depth of field on the captured moving image data 109. The depth of field refers to the range of distances from the imaging apparatus 200 to an object to be imaged where the object can be regarded to be in focus. The imaging apparatus 200 calculates the depth of field from the focal length (angle of view) of the lens of the optical unit 201, F-number, and the sensor size of the imaging unit 202.

### Example of Combined Moving Image Data Displayed on Display Unit

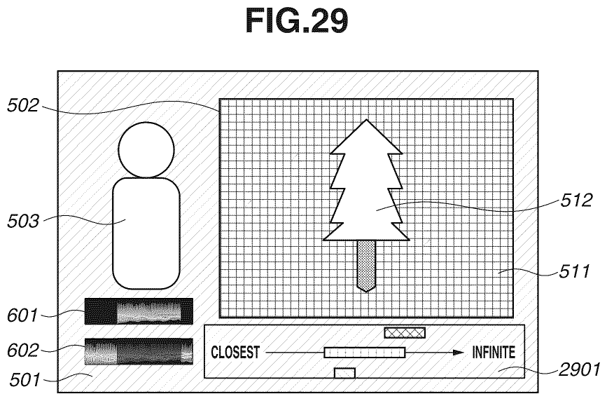

FIG. 29 is a diagram illustrating an example of the combined moving image data. The horizontal axis of a distance graph 2901 indicates distances where the imaging apparatus 200 can focus (from closest imaging distance to infinite distance). The distance graph 2901 is an indicator indicating the range of distances from the imaging apparatus 200 to the display apparatus 300, the range of distances from the imaging apparatus 200 to the actor 503, and the depth of field about the distance where the imaging apparatus 200 is focused. In FIG. 29, elements denoted by the same reference numerals as in FIG. 5 are similar ones. The combined moving image data illustrated in FIG. 29 is obtained by combining the captured moving image data illustrated in FIG. 5 with a waveform monitor 601 visualizing characteristics analyzed from the virtual area of the moving image data, a waveform monitor 602 visualizing characteristics analyzed from the real area of the moving image data, and the distance graph 2901.

### Drawing Example of Distance Graph

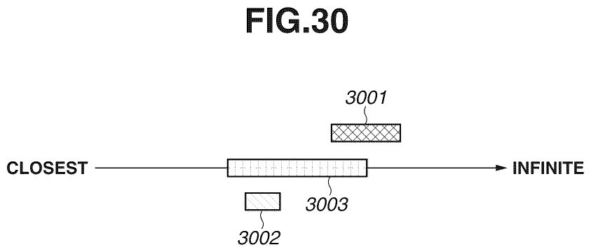

FIG. 30 is a diagram illustrating details of the distance graph 2901. A virtual distance 3001 indicates the range of distances from the imaging apparatus 200 to the display apparatus 300. The generation unit 107 acquires the range of distances from the imaging apparatus 200 to the display apparatus 300, which is superimposed on the captured moving image data 109 by the imaging apparatus 200, and draws the virtual distance 3001 and outputs the virtual distance 3001 to the combination unit 105. A real distance 3002 indicates the range of distances from the imaging apparatus 200 to the actor 503. The generation unit 108 acquires the range of distances from the imaging apparatus 200 to the actor 503, which is superimposed on the captured moving image data 109 by the imaging apparatus 200, and draws the real distance 3002 and outputs the real distance 3002 to the combination unit 105. A not-illustrated depth of field drawing unit of the signal processing apparatus 100 acquires the depth of field superimposed on the captured moving image data 109 by the imaging apparatus 200, and draws a depth of field 3003 and outputs the depth of field 3003 to the combination unit 105. The combination unit 105 combines the moving image data with the waveform monitor 601, the waveform monitor 602, and the distance graph 2901 (virtual distance 3001, real distance 3002, and depth of field 3003), and outputs the resulting moving image data to the display unit 106 as the combined moving image data. The display unit 106 displays the combined moving image data.

The generation unit 107, the generation unit 108, and the not-illustrated depth of field generation unit draw the virtual distance 3001, the real distance 3002, and the depth of field 3003 in respective visually different modes.

For example, the virtual distance 3001 is drawn in dark gray, the real distance 3002 in medium light gray, and the depth of field 3003 in dark gray. The generation unit 107 draws the virtual distance 3001 in a case where the area information output from the detection unit 102 includes a virtual area. The generation unit 108 draws the real distance 3002 in a case where the area information output from the detection unit 102 includes a real area.

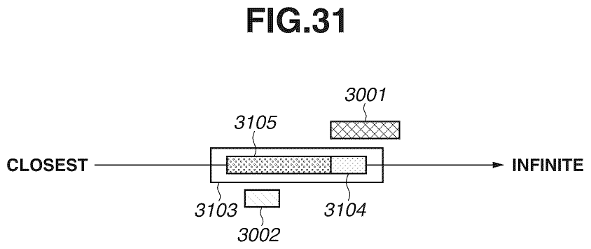

An example different from that illustrated in FIG. 30 will be described. FIG. 31 is a diagram illustrating details of the distance graph 2901. Part of the depth of field 3103 where the distance overlaps the virtual distance 3001 is drawn in a first mode (depth of field 3104). Part of the depth of field 3104 where the distance does not overlap the virtual distance 3001 is drawn in a second mode (depth of field 3105). It is sufficient for the first mode and the second mode to be visually distinguishable. For example, the first mode can be drawn in red, and the second mode in medium light gray. Elements denoted by the same reference numerals as in FIG. 30 are similar to those of FIG. 30.

The virtual distance 3001 may be drawn in two modes. For example, part of the virtual distance 3001 where the distance overlaps the depth of field 3003 is drawn in a first mode. Part of the virtual distance 3001 where the distance does not overlap the depth of field 3003 is drawn in a second mode.

### Effects of the Present Exemplary Embodiment

According to the present exemplary embodiment, the user does not need to specify areas when separately analyzing the virtual area and the real area. Moiré caused by the LED wall coming into focus against the user's intention can be reduced by adjusting the focus while referring to the distance graph. Moreover, since the distances where the depth of field and the virtual distance overlap are drawn in a different mode, the user can easily find out that the LED wall is in focus. This can further reduce moiré caused by the LED wall coming into focus against the user's intention.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-171951, filed Oct. 3, 2023, which is hereby incorporated by reference herein in its entirety.

What is claimed is:

1. A signal processing apparatus comprising:
one or more processors that execute a program stored in a memory and thereby function as:
a first acquisition unit configured to acquire image data obtained by an imaging apparatus capturing an image of an object and a background video image displayed on a background display;
an extraction unit configured to extract information about a background video image area and an object area in the image data;
a first generation unit configured to generate a first indicator indicating at least one of characteristics including luminance, color, and a spatial frequency of the background video image area;
a second generation unit configured to generate a second indicator indicating a same type of characteristic as a type of the first indicator generated by the first generation unit among characteristics including luminance, color, and a spatial frequency of the object area; and
a combination unit configured to output combined image data by combining the first indicator, the second indicator, and the image data.

2. The signal processing apparatus according to claim 1,
wherein the one or more processors further function as a second acquisition unit configured to acquire a reference value based on a characteristic or setting of the background display, and
wherein the combination unit is configured to output the combined image data with the reference value drawn on the first indicator.

3. The signal processing apparatus according to claim 2, wherein the reference value is at least one of a luminance of 200 nits, a luminance of 203 nits, a maximum luminance of the background display, a luminance corresponding to a reflectance of 18%, and a luminance corresponding to a reflectance of 100%.

4. The signal processing apparatus according to claim 2, wherein the reference value is at least one of a chromaticity of achromatic color of the background display, a chromaticity of red in a color gamut of the background display, a chromaticity of green in the color gamut of the background display, and a chromaticity of blue in the color gamut of the background display.

5. The signal processing apparatus according to claim 1,
wherein the one or more processors further function as:
a third acquisition unit configured to acquire background video image data; and
a third generation unit configured to generate a third indicator indicating the same type of characteristic as the type of the first indicator generated by the first generation unit among luminance, color, and a spatial frequency of an area of the background video image data, the area corresponding to the background video image area, and
wherein the combination unit is configured to output the combined image data combined with the third indicator.

6. The signal processing apparatus according to claim 5, wherein the one or more processors further function as a conversion unit configured to convert the background video image data based on an imaging range of the imaging apparatus.

7. The signal processing apparatus according to claim 5, wherein the third indicator is a waveform monitor, a vectorscope, or a chromaticity diagram.

8. The signal processing apparatus according to claim 1,
wherein the one or more processors further function as:
a first calculation unit configured to calculate a first average value, the first average value being an average value of the same type of characteristic as the type of the first indicator generated by the first generation unit among the luminance, color, and spatial frequency of the background video image area in the image data acquired by the first acquisition unit;
a third acquisition unit configured to acquire background video image data; and
a second calculation unit configured to calculate a second average value, the second average value being an average value of the same type of characteristic as the type of the first indicator generated by the first generation unit among the luminance, color, and spatial frequency of an area of the background video image data, the area corresponding to the background video image area, and
wherein the combination unit is configured to output the combined image data combined with the first average value and the second average value.

9. The signal processing apparatus according to claim 1,
wherein the one or more processors further function as a fourth generation unit configured to generate a fourth indicator indicating the same type of characteristic as the type of the first indicator generated by the first generation unit among luminance, color, and a spatial frequency of an entire area of the image data acquired by the first acquisition unit, and
wherein the combination unit is configured to output the combined image data combined with the fourth indicator.

10. The signal processing apparatus according to claim 9,
wherein the combination unit is configured to output, in a case where the extraction unit successfully acquires the information about the background video image area and the object area in the image data, the combined image data by combining the first indicator, the second indicator, and the image data, and
wherein the combination unit is configured to output, in a case where the extraction unit fails to acquire the information about the background video image area and the object area in the image data, combined image data by combining the fourth indicator and the image data.

11. The signal processing apparatus according to claim 9,
wherein the combination unit is configured to output, in a case where the extraction unit successfully acquires the information about the background video image area and the object area in the image data, combined image data by combining the first indicator, the second indicator, the fourth indicator, and the image data, and
wherein the combination unit is configured to output, in a case where the extraction unit fails to acquire the information about the background video image area and the object area in the image data, combined image data by combining the fourth indicator and the image data.

12. The signal processing apparatus according to claim 9, wherein the fourth indicator is a waveform monitor, a vectorscope, or a chromaticity diagram.

13. The signal processing apparatus according to claim 1, wherein the first indicator and the second indicator are waveform monitors, vectorscopes, or chromaticity diagrams.

14. The signal processing apparatus according to claim 1, wherein the one or more processors further function as a control unit configured to control display of the combined image data output by the combination unit on a display unit.

15. A signal processing apparatus comprising one or more processors that execute a program stored in a memory and thereby function as:
a first acquisition unit configured to acquire image data obtained by an imaging apparatus capturing an image of an object;
a third acquisition unit configured to acquire background video image data;
a first combination unit configured to combine the image data and the background video image data into a piece of image data, and extract information about a background video image area and an object area in the one piece of image data;
a first generation unit configured to generate a first indicator indicating a characteristic of the one piece of image data in the background video image area;
a second generation unit configured to generate a second indicator indicating the characteristic of the one piece of image data in the object area; and
a combination unit configured to output combined image data by combining the first indicator, the second indicator, and the one piece of image data.

16. The signal processing apparatus according to claim 15,
wherein the first indicator and the second indicator are graphs visualizing a characteristic of a spatial frequency,
wherein the first generation unit is configured to draw the graph with frequency domains lower and higher than a first threshold in respective different modes,
wherein the second generation unit is configured to draw the graph with frequency domains lower and higher than a second threshold in respective different modes, and
wherein the first threshold is lower than the second threshold.

17. The signal processing apparatus according to claim 15, wherein the combination unit is configured to output combined image data obtained by combining a fifth indicator and the one piece of image data, the fifth indicator indicating at least one of a range of distances between the object and the imaging apparatus, a range of distances between the background display and the imaging apparatus, a range of distances where the imaging apparatus focuses, and a depth of field about a distance at which the imaging apparatus is focusing.

18. The signal processing apparatus according to claim 17, wherein the fifth indicator is a distance graph.

19. A method of controlling a signal processing apparatus comprising
acquiring image data obtained by an imaging apparatus capturing an image of an object and a background video image displayed on a background display;
extracting information about a background video image area and an object area in the image data;
generating a first indicator indicating at least one of characteristics including luminance, color, and a spatial frequency of the background video image area;
generating a second indicator indicating a same type of characteristic as a type of the first indicator generated by a first generation unit among characteristics including luminance, color, and a spatial frequency of the object area; and
outputting combined image data by combining the first indicator, the second indicator, and the image data.

20. A non-transitory computer-readable storage medium storing a program for causing a computer to execute the control method according to claim 19.
